(19) United States
(12) Patent Application Publication
(10) Pub. No.: US 2016/0289022 A1
(43) Pub. Date: Oct. 6, 2016

(54) SHEET FEEDING DEVICE AND IMAGE FORMING APPARATUS

(71) Applicant: CANON KABUSHIKI KAISHA, Tokyo (JP)

(72) Inventors: Kazumasa Shibata, Kawasaki-shi (JP); Hiroki Kasama, Kashiwa-shi (JP); Yasumi Yoshida, Yokohama-shi (JP); Tadashi Matsumoto, Tokyo (JP); Takashi Hiratsuka, Kashiwa-shi (JP); Takeshi Aoyama, Kawasaki-shi (JP); Takaaki Aoyagi, Kawasaki-shi (JP)

(21) Appl. No.: 14/777,616

(22) PCT Filed: Mar. 20, 2014
(86) PCT No.: PCT/JP2014/057764

§ 371 Date: Sep. 16, 2015

Related U.S. Application Data
(63) Continuation of application No. PCT/JP2014/057764, filed on Mar. 20, 2014.

(30) Foreign Application Priority Data
Apr. 12, 2013 (JP) 2013-083583

(51) Int. Cl. B65H 3/18; B65H 7/18; H04N 1/00; B65H 7/20

(52) U.S. Cl. CPC B65H 3/18; B65H 7/20; B65H 7/18; H04N 1/0057; B65H 2553/51; B65H 2555/41; H04N 2201/0082

(57) ABSTRACT

Provided are a sheet feeding device and an image forming apparatus which can feed a sheet by an electrostatic adsorption with a simple configuration and with low noises.

One end of a flexible adsorption member (29) is fixed to a holding member (24) rotating in a sheet feeding direction, and comes into surface contact with a sheet (P) stored in a sheet feeding cassette (20) while being elastically deformed when the holding member (24) is rotated, and adsorbs the sheet (P) by an adsorbing force by static electricity. Then, the sheet (P1) adsorbed to the adsorption member (29) is delivered to a registration roller (15) while winding up the adsorption member (29), and then the holding member (24) is stopped at a position where the adsorption member (29) is separated from the sheet.

### TECHNICAL FIELD

The present invention relates to a sheet feeding device and an image forming apparatus, and particularly to a device that feeds a sheet using an electrostatic adsorbing force.

### BACKGROUND ART

An image forming apparatus such as a copying machine or a printer in the related art is provided with a sheet feeding device which feeds a sheet such as plain paper, coated paper, or OHP paper. In general, the image forming apparatus conveys the sheet fed by the sheet feeding device to the image forming section to form an image on the sheet. As such a sheet feeding device, there are a friction feeding method in which the uppermost sheet is separately fed out of a cassette loaded with a sheet bundle using a friction force of a feeding roller, and an air feeding method which adsorbs and conveys the sheet using the air.

By the way, in recent years, noise damping is required in the sheet feeding device, and it is important that the operation sound is suppressed as low as possible. However, in the sheet feeding device using the friction force by the feeding roller, there occurs screechy noises between the sheet and the roller or between the sheets. Further, in the air feeding method, the apparatus is increased in size so that the operation sound is also increased.

As a feeding method receiving the attention in recent years, there is an electrostatic adsorption method in which the sheet is adsorbed using static electricity and conveyed. Further, according to the electrostatic adsorption method, the sheet can be fed without using the friction force, so that it is advantageous for the sound damping. As a sheet feeding device of such an electrostatic adsorption method, there is a device configured such that the sheet is adsorbed to an endless belt and then conveyed using the endless belt while being oscillated (see Patent Literature 1). In addition, the sheet is adsorbed to a plate having an electrostatic adsorption function, and then the plate horizontally moves to convey the sheet (see Patent Literature 2).

### CITATION LIST

### Patent Literature

Patent Literature 1: Japanese Patent Laid-Open No. 2011-63391

Patent Literature 2: Japanese Patent Laid-Open No. 6-40583

### SUMMARY OF INVENTION

### Technical Problem

However, in such a sheet feeding device of the conventional electrostatic adsorption method, the structure becomes complicated in the configuration for conveying the sheet using the endless belt adsorbing the sheet while being oscillated, and the configuration for horizontally moving the plate adsorbing the sheet. Then, in a system having a complicated structure, noises caused by the driving are increased. Therefore, it is disadvantageous for the sound damping.

Therefore, the invention has been made in view of such circumstances, and an object thereof is to provide a sheet feeding device and an image forming apparatus which can feed the sheet by electrostatic adsorption with a simple configuration and with low noises.

### Solution to Problem

According to the invention, there is provided a sheet feeding device which includes a loading portion configured to be loaded with a sheet, a rotation member configured to be disposed on an upper side of the loading portion, an adsorption member configured to have ends and to be provided such that a part of the adsorption member is fixed to the rotation member and the sheet loaded on the loading portion is electrically adsorbed, a driving unit configured to rotate the rotation member, and a control unit configured to control the driving unit.

### Advantageous Effects of Invention

With the invention, an adsorption member is rotated to adsorb the sheet, delivers the adsorbed sheet to a sheet conveying unit, and then the adsorption member is stopped at a position where the sheet is separated. Therefore, it is possible to feed the sheet by electrostatic adsorption with a simple configuration and with low noises.

### BRIEF DESCRIPTION OF DRAWINGS

FIG. 1 is a diagram illustrating the entire configuration of a full-color laser beam printer as an example of an image forming apparatus provided with a sheet feeding device according to a first embodiment of the invention.

FIG. 2 is a diagram for describing a configuration of the sheet feeding device.

FIG. 3 is a diagram for describing a holding member included in an adsorbing and feeding section of the sheet feeding device.

FIG. 4 is a diagram for describing a configuration of the adsorbing and feeding section.

FIG. 5 is a control block diagram of the full-color laser beam printer.

FIG. 6 is a diagram for describing a sheet separating and feeding operation of the sheet feeding device.

FIG. 7 is a flowchart of the sheet separating and feeding operation of the sheet feeding device.

FIG. 8 is a diagram for describing a sheet adsorbing operation of the sheet feeding device.

FIG. 9 is a diagram for describing other configurations of the adsorbing and feeding section.

FIG. 10 is a diagram for describing a configuration of a sheet feeding device according to a second embodiment of the invention.

FIG. 11 is a diagram for describing a configuration of an adsorbing and feeding section of the sheet feeding device.

FIG. 12 is a diagram for describing a voltage applying operation of the adsorbing and feeding section.

FIG. 13 is a diagram for describing a sheet separating and feeding operation of the sheet feeding device.

FIG. 14 is a flowchart of the sheet separating and feeding operation of the sheet feeding device.

### DESCRIPTION OF EMBODIMENTS

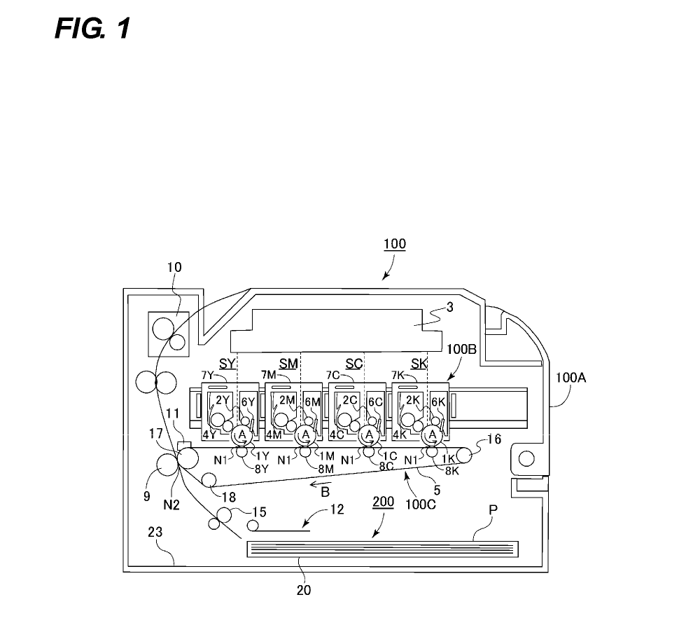

Hereinafter, embodiments of the invention will be described in detail using the drawings. FIG. 1 is a diagram illustrating the entire configuration of a full-color laser beam printer as an example of an image forming apparatus provided with a sheet feeding device according to a first embodiment of the invention. In FIG. 1, a full-color laser beam printer 100 and a full-color laser beam printer body 100A (hereinafter, referred to as a printer body) are illustrated. The printer body 100A serving as a main body includes the image forming section 100B which forms an image on a sheet such as a recording sheet, a plastic sheet, or cloth, and a sheet feeding device 200 which feeds the sheet.

The image forming section 100B includes process cartridges 7 (7Y, 7M, 7C, and 7K) which form toner images of four colors (yellow, magenta, cyan, and black). Further, the process cartridges 7 include photosensitive drums 1 (1Y, 1M, 1C, and 1K) which serve as image bearing members rotatably driven by a driving unit (a driving source; not illustrated) in a direction of arrow A (a counterclockwise direction), and is mounted to be detachably attachable to the printer body 100A.

In addition, the image forming section 100B includes a scanner unit 3 which is disposed on the upper side of the process cartridges 7 in a vertical direction, irradiates the photosensitive drums 1 with laser beams based on image information, and forms electrostatic latent images on the photosensitive drums 1. Further, the process cartridges 7 includes, besides the photosensitive drums 1, developing units 4 (4Y, 4M, 4C, and 4K) which attach toner to the electrostatic latent images to visualize the latent images, and charging rollers 2 (2Y, 2M, 2C, and 2K) which evenly charge the surfaces of the photosensitive drums.

In addition, the image forming section 100B includes an intermediate transfer belt unit 100C, a secondary transfer portion N2, and a fixing portion 10. The intermediate transfer belt unit 100C includes an endless intermediate transfer belt 5, and primary transfer rollers 8 (8Y, 8M, 8C, and 8K) which are disposed inside the intermediate transfer belt 5 to face the photosensitive drums 1. The intermediate transfer belt 5 rotates in a direction of arrow B while abutting on all the photosensitive drums 1 and suspending on a drive roller 16, a secondary transfer counter roller 17, and a driven roller 18.

Herein, the primary transfer rollers 8 presses the intermediate transfer belt 5 toward the photosensitive drum 1, forms a primary transfer portion N1 which abuts on the intermediate transfer belt 5 and the photosensitive drum 1, and applies a transfer bias to the intermediate transfer belt 5 by a bias applying unit (not illustrated). Then, a primary transfer bias is applied to the intermediate transfer belt 5 by the primary transfer rollers 8, and the respective color toner images on the photosensitive drums are sequentially transferred onto the intermediate transfer belt 5, thereby forming a full-color image on the intermediate transfer belt.

In addition, the secondary transfer roller 9 is disposed at a position facing the secondary transfer counter roller 17 on an outer peripheral surface of the intermediate transfer belt 5, and comes in press contact with the secondary transfer counter roller 17 through the intermediate transfer belt 5 to form the secondary transfer portion N2. Then, the toner images on the intermediate transfer belt 5 are transferred onto a sheet P (the secondary transfer) by applying a bias having an opposite-polarity with respect to a normal charge polarity of the toner from a secondary transfer bias power source (a high-voltage power source) serving as a secondary transfer bias applying unit (not illustrated) to the secondary transfer roller 9.

The sheet feeding device 200 includes a sheet feeding cassette 20 which is mounted to be detachably attachable to the printer body 100A, and an adsorbing and feeding section 12 which adsorbs a plurality of sheets P stored in the sheet feeding cassette 20 and feeds the sheets. Then, when the sheet P stored in the sheet feeding cassette 20 is fed, the sheet P is adsorbed by the adsorbing and feeding section 12 and fed out.

Next, an image forming operation of the full-color laser beam printer 100 having such a configuration will be described. When an image reading apparatus (not illustrated) connected to the printer body 100A, or an image signal from a host machine such as a personal computer is input to the scanner unit 3, the photosensitive drum is irradiated with the laser beam corresponding to the image signal from the scanner unit 3. At this time, the surfaces of the photosensitive drums 1 are evenly charged with a polarity and a voltage determined in advance by the charging rollers 2. The electrostatic latent images are formed on the surfaces by irradiating with the laser beams from the scanner unit 3. Thereafter, the electrostatic latent images are developed and visualized by the developing units 4.

For example, first, the photosensitive drum 1Y is irradiated with the laser beam by the image signal of a yellow component from the scanner unit 3, and a yellow electrostatic latent image is formed in the photosensitive drum. Then, the yellow electrostatic latent image is developed by the yellow toner from the developing unit 4Y, and visualizes the latent image into a yellow toner image. Thereafter, the toner image reaches the primary transfer portion N1 where the photosensitive drum 1Y and the intermediate transfer belt 5 abut on each other according to the rotation of the photosensitive drum 1Y. Then, the yellow toner image on the photosensitive drum is transferred onto the intermediate transfer belt in the primary transfer portion N1 by the primary transfer bias applied to the primary transfer roller 8Y.

Next, when a portion carrying with the yellow toner image of the intermediate transfer belt 5 moves, a magenta toner image formed on the photosensitive drum 1M is transferred from above the yellow toner image to the intermediate transfer belt 5 by the method similar to the above description until this stage. Similarly, a cyan toner image and a black toner image are transferred onto the yellow toner image and the magenta toner image in an overlapping manner in the respective primary transfer portions as the intermediate transfer belt 5 moves. Therefore, a full-color toner image is formed on the intermediate transfer belt.

In addition, the sheet P stored in the sheet feeding cassette 20 is fed out by the adsorbing and feeding section 12 in parallel to the toner image forming operation, and then conveyed to a registration roller 15 serving as a sheet conveyance unit provided on the downstream side in a sheet feeding direction of the adsorbing and feeding section 12. Next, the sheet P conveyed to the registration roller 15 is conveyed to the secondary transfer portion N2 by the registration roller 15 in synchronization with timing. Then, in the secondary transfer portion N2, the four-color toner image on the intermediate transfer belt 5 is secondarily transferred onto the conveyed sheet P by applying a positive bias to the secondary transfer roller 9. Further, after the toner image is secondarily transferred, the toner left on the intermediate transfer belt 5 is removed by a belt cleaner 11. Next, the sheet P on which the toner image is transferred is conveyed to the fixing portion 10 and heated and pressed therein, so that the full-color toner image is fixed as a permanent image, and then discharged to the outside of the printer body 100A.

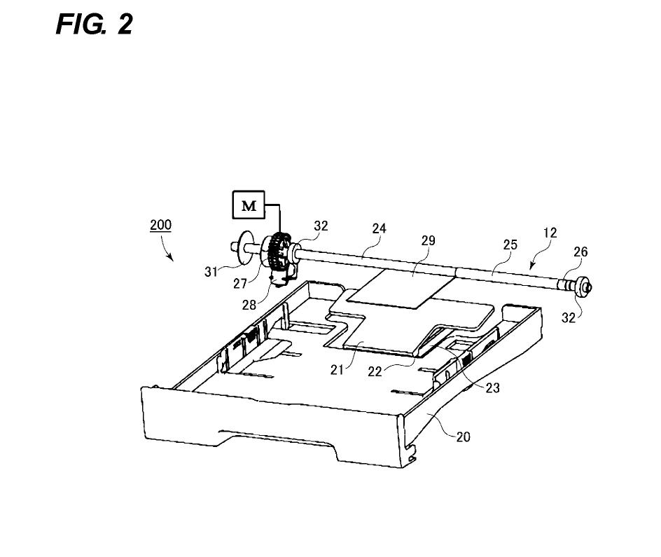

Next, the sheet feeding device 200 according to this embodiment will be described using FIG. 2. As illustrated in FIG. 2, the adsorbing and feeding section 12 includes an adsorption member 29 and a holding member 24 serving as an axial holding unit which holds the adsorption member 29. The holding member 24 is disposed on the upper side at the downstream end in the sheet feeding direction of the sheet feeding cassette 20, and the adsorption member 29 is fixed at the center portion in a width direction perpendicular to the sheet feeding direction of the holding member 24. Further, in FIG. 2, a sheet supporting plate 21 is provided in a housing 23 provided at the bottom surface of the printer body 100A to freely rotate in the vertical direction about a fulcrum 22. The sheet supporting plate 21 may be disposed not in the housing 23 but in the sheet feeding cassette 20.

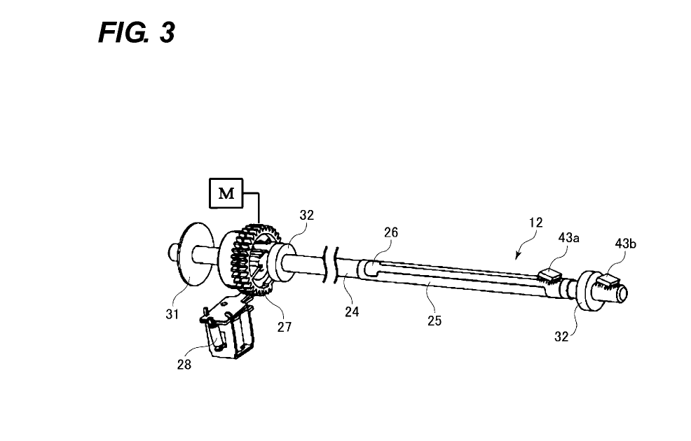

The holding member 24 is a shaft formed from a conductive material (for example, SUS303), and the both ends are held by bearings 32 provided in the printer body 100A as illustrated in FIG. 3 to freely rotate. In addition, an insulating tape 25 is attached to one end of the holding member 24, and a power electrode 26 is formed on the insulating tape 25. Then, the power electrode 26 comes into contact with a first power brush 43a, and the holding member 24 comes into contact with a second power brush 43b which applies a voltage different from that of the power electrode 26 to the holding member 24.

Therefore, the holding member 24 and the power electrode 26 can be applied with different voltages. Further, in this embodiment, the different voltages are applied to the holding member 24 and the power electrode 26 using the power brushes 43a and 43b, but any method of supplying the power may be employed as long as the power can be applied to the rotating member.

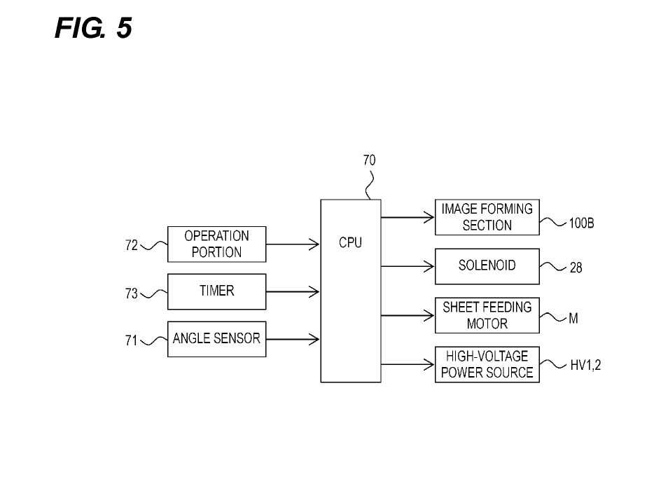

In addition, the other end of the holding member 24 is attached to a partially toothed gear 27, and transmitted with drive transmission from a sheet feeding motor M through the partially toothed gear 27 when a solenoid 28 is turned on, so that the holding member 24 rotates. Herein, an initial rotation angle of the holding member 24 indicating a home position (initial position) of the adsorption member 29 is set at a position of the partially toothed gear 27 of which the rotation is regulated by the solenoid 28. Further, an encoder 31 is attached to the holding member 24, and the rotation position (phase) of the encoder 31 is detected by an angle sensor 71 (described below) illustrated in FIG. 5, so that a rotation angle θ of the holding member 24 can be detected.

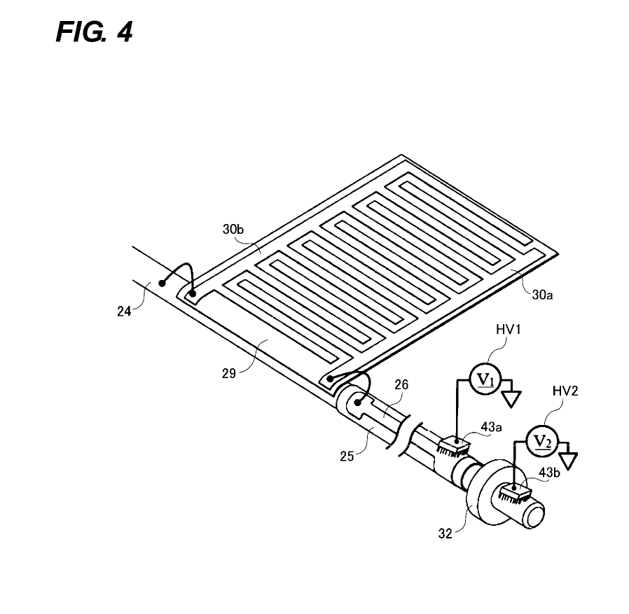

As illustrated in FIG. 4, the adsorption member 29 has a cantilever structure in which one end is fixed to the holding member 24. The adsorption member 29 can be preferably manufactured using a flexible resin sheet, and PVDF having a volume resistivity of 1013 [Ω/cm] or so may be employed. In addition, the adsorption member 29 may be configured to have a thickness of 0.1 mm, a width of 50 mm, and a length of 100 mm or so. In addition, the adsorption member 29 includes a first comb-tooth electrode 30a and a second comb-tooth electrode 30b therein. The first and the second comb-tooth electrodes 30a and 30b are configured such that the two electrodes 30a and 30b in the adsorption member 29 are alternately disposed in a stripe shape, so that the power can be individually supplied to the electrodes 30a and 30b.

As design values of the first and the second comb-tooth electrodes 30a and 30b, a thickness of 0.7 μm, an electrode width of 6 mm, and an electrode pitch of 2 mm or so may be used. In addition, the first comb-tooth electrode (a first electrode) 30a as one electrode is wired to the power electrode 26, and the second comb-tooth electrode (a second electrode) 30b as the other electrode is wired to the holding member 24. Further, in this embodiment, a voltage V1 is applied from a high-voltage power source (a first power source) HV1 to the power electrode 26 through the first power brush 43a, and a voltage V2 is applied from a high-voltage power source (a second power source) HV2 to the holding member 24 through the second power brush 43b.

FIG. 5 is a control block diagram of the full-color laser beam printer according to this embodiment. In FIG. 5, a CPU 70 is illustrated as a controller. The CPU 70 is connected to the above-described image forming section 100B, the sheet feeding motor M, the solenoid 28, the high-voltage power sources HV1 and HV2, the angle sensor 71 serving as a rotation angle detection unit which detects the rotation angle θ of the holding member 24 by the encoder 31, an operation portion 72, and a timer 73.

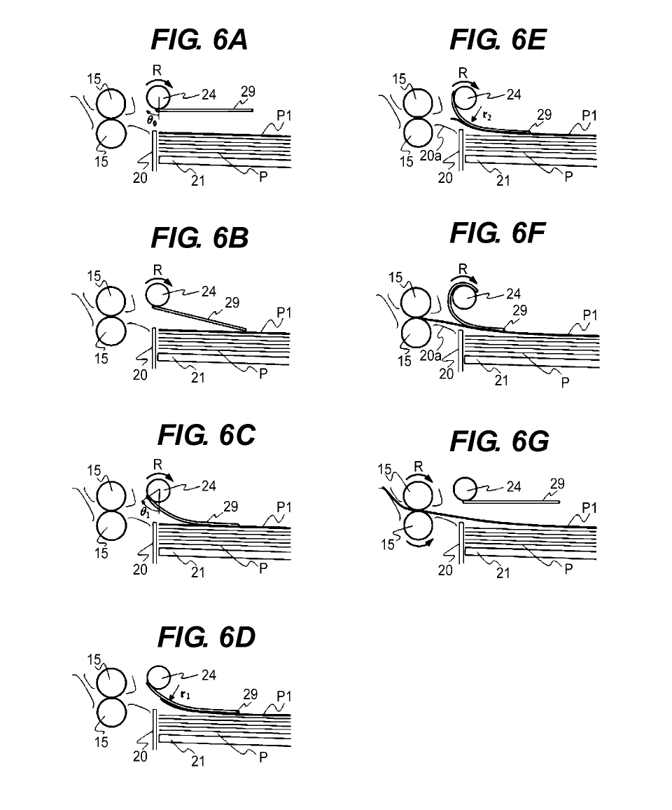

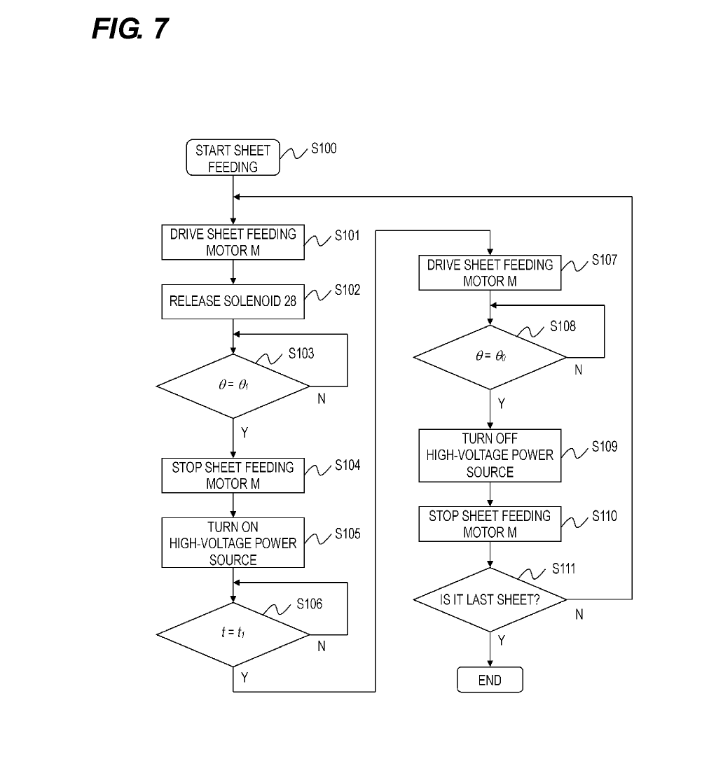

Next, a sheet separating and feeding operation of the sheet feeding device 200 according to this embodiment will be described using FIG. 6 and a flowchart of illustrated in FIG. 7. (a) of FIG. 6 is a diagram illustrating an initial state of the sheet feeding device 200 in this embodiment. The rotation angle θ of the holding member 24 at this time is set to an initial rotation angle θ0, and the position is set to the home position (initial position) of the adsorption member 29. In the initial state, the adsorption member 29 is in a non-contact state with respect to the uppermost sheet P1 among the sheets P loaded on the sheet supporting plate 21. In addition, the position of the uppermost sheet P1 is regulated by the position of the sheet supporting plate 21.

Next, when the sheet P begins to be fed, the CPU 70 causes the sheet feeding motor M to be driven (S101), releases the solenoid 28 (S102), and causes the holding member 24 to be rotated in the sheet feeding direction indicated with arrow R in (a) of FIG. 6. The adsorption member 29 moves downward as the holding member 24 rotates, and then comes into contact with the uppermost sheet P1 as illustrated in (b) of FIG. 6. Thereafter, when the holding member 24 keeps on rotating, the adsorption member 29 starts to be elastically deformed along the uppermost sheet P1. In this way, when the adsorption member 29 is deformed, a surface contact area between the adsorption member 29 and the uppermost sheet P1 is gradually increased.

When it is determined that the surface contact area becomes sufficient for the adsorption, that is, when it is determined that the rotation angle θ of the holding member 24 becomes θ1 as illustrated in (c) of FIG. 6 (Y of S103), the CPU 70 stops the sheet feeding motor M (S104) and stops the rotation of the holding member 24. Further, in this embodiment, the CPU 70 determines that the rotation angle θ of the holding member 24 becomes θ1 using the encoder 31, but the rotation angle θ at which the rotation is stopped may be calculated using the timer 73 illustrated in FIG. 5.

Next, the CPU 70 turns on the high-voltage power source in a state where the holding member 24 stops rotating (S105), and applies a voltage to the power electrode 26 and the holding member 24. The adsorbing force of the adsorption member 29 is determined according to the magnitude of the applied voltage. Further, when the applied voltage is large too much, dielectric breakdown occurs in the first and the second comb-tooth electrodes 30a and 30b. Therefore, in this embodiment, a positive voltage V applied to the power electrode 26 is set to 1 kV, and a negative voltage V2 applied to the holding member 24 is about −1 kV.

Then, when such voltages are applied to the power electrode 26 and the holding member 24, a potential pattern alternating in a stripe shape is formed in the surface of the adsorption member 29 by the first and the second comb-tooth electrodes 30a and 30b, and the adsorbing force is generated. Herein, the generated electric field is shown only near the surface of the adsorption member 29, so that the adsorbing force is worked only on the uppermost sheet P1. Therefore, it is possible to separate the uppermost sheet P1 from the loaded sheets P as illustrated in (d) of FIG. 6.

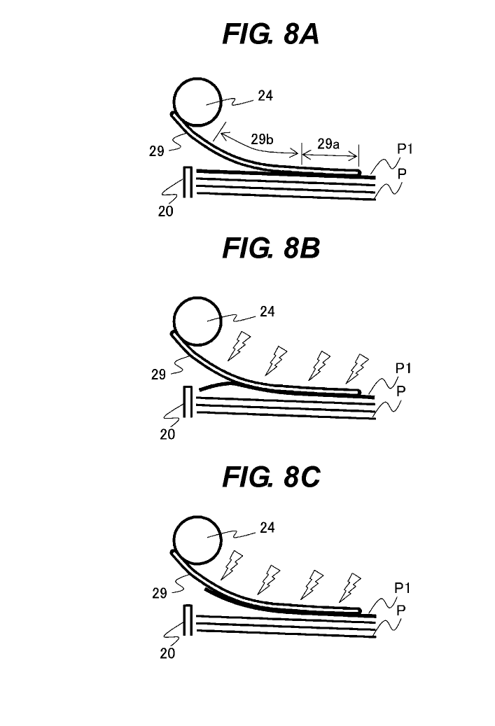

FIG. 8 is a diagram for describing an adsorbing operation at this time in detail. (a) of FIG. 8 illustrates a state before the voltage is applied to the power electrode 26 and the holding member 24. At this time, the adsorption member 29 includes a first adsorption portion 29a which is in a state of coming into contact with the uppermost sheet P1, and a second adsorption portion 29b which is disposed on the downstream side in the sheet feeding direction of the first adsorption portion 29a and in the non-contact state. Next, when the voltage application starts, since the first adsorption portion 29a is already into contact with the uppermost sheet P1, the uppermost sheet P1 is adsorbed in a short time.

With this regard, in the second adsorption portion 29b, the uppermost sheet P1 is slowly adsorbed from a position near the first adsorption portion 29a as illustrated in (b) of FIG. 8. Therefore, the uppermost sheet P1 can be turned up as illustrated in (c) of FIG. 8. Herein, in this embodiment, since the uppermost sheet P1 can be separated without using a friction force, there is no screechy noises between the roller and the sheet which occur in a general roller feeding structure, so that there comes a low noise state.

When a counted time t of the timer 73 becomes t1 to stop the rotation of the holding member 24 so as to separate the uppermost sheet P1 (Y in S106), the CPU 70 cause the sheet feeding motor M to be rotated (S107) so as to start rotating of the holding member 24 in a direction of arrow R as illustrated in (e) of FIG. 6. Herein, a time t1 taken until the rotation is restarted after the holding member 24 stops rotating is detected using the timer 73 in this embodiment, but the adsorption of the uppermost sheet P1 may be detected using a sensor so as to restart the rotation.

When the holding member 24 restarts the rotation in a state where the uppermost sheet P1 is adsorbed, the adsorption member 29 is wound up by the holding member 24 while being deformed to make a portion of the holding member 24 on the downstream side in the sheet feeding direction wound to the holding member 24. In this way, a curvature radius r2 of the adsorption member 29 at the time of conveyance illustrated in (e) of FIG. 6 becomes smaller than a curvature radius r1 of the adsorption member 29 at the time of adsorption illustrated in (d) of FIG. 6. In other words, in this embodiment, a rigidity, a size of the adsorption member 29, and the position of the holding member 24 are set such that the curvature radius of the adsorption portion of the uppermost sheet P1 with respect to the adsorption member 29 becomes smaller when the adsorption member 29 is wound up so as to be wound to the holding member 24. At this time, a portion of the uppermost sheet P1 on the downstream side in the sheet feeding direction abuts on a portion of the adsorption member 29 on the downstream side in the sheet feeding direction. In this way, when a difference in the curvature radius of the adsorption member 29 is generated, the uppermost sheet P1 is separated from the adsorption member 29 by the elasticity of the sheet.

Thereafter, when the holding member 24 is rotated again, the adsorption member 29 moves, the uppermost sheet P1 in a state where the portion on the downstream side in the sheet feeding direction is separated from the adsorption member 29 is guided toward the registration roller 15 by a guide member 20a. Then, the leading end of the uppermost sheet P1 reaches the registration roller 15 as illustrated in (f) of FIG. 6. Further, thereafter, when the holding member 24 is rotated and the partially toothed gear 27 returns to the initial position, the drive transmission is stopped.

Thereafter, when it is determined that the rotation angle θ of the holding member 24 detected by the angle sensor 71 becomes the initial rotation angle θ0 (Y in S108), the CPU 70 turns off the high-voltage power source (S109), stops the voltage application to the adsorption member 29, and stops the sheet feeding motor M (S110). Therefore, as illustrated in (g) of FIG. 6, the holding member 24 is stopped, and the adsorption member 29 returns to the initial position where the sheet is separated and then stopped thereat. Further, thereafter, in a case where a continuous sheet feeding is performed, that is, a case where the fed sheet is not the last one (N in S111), the sheet feeding motor M is driven again, the solenoid 28 is released, and the sheet feeding is performed until the last sheet comes (Y in S111).

As described above, in this embodiment, when the adsorption member 29 comes in surface contact with the sheet, the rotation of the holding member 24 is temporarily stopped and a voltage is applied to the adsorption member 29, and the adsorbing force is applied to adsorb the sheet by the static electricity, so that the sheet is adsorbed to the adsorption member 29. Next, when the sheet is adsorbed, the holding member 24 restarts the rotation and delivers the adsorbed sheet to the registration roller 15 while winding up the adsorption member 29, and then makes the adsorption member 29 stopped at a position where the sheet is separated.

With such a configuration, the configuration can be simplified, and the screechy noises can be reduced. In other words, the adsorption member 29 is rotated to adsorb the sheet, delivers the adsorbed sheet to the registration roller 15, and then the adsorption member 29 is stopped at a position where the sheet is separated. Therefore, it is possible to feed the sheet by electrostatic adsorption with a simple configuration and with low noises.

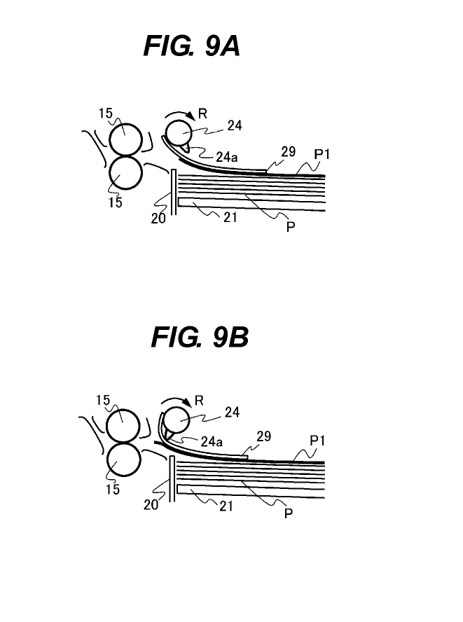

Further, in this embodiment, the uppermost sheet P1 is separated while suppressing the curvature radius of the adsorption member 29 small, for example, as illustrated in (a) of FIG. 9, a projection 24a serving as a pressing portion may be provided in the holding member 24 to make sure of the separation of the uppermost sheet P1. Then, with such a projection 24a, the projection 24a comes to press the adsorption member 29 at the time of the conveyance illustrated in (b) of FIG. 9, the curvature radius appeared in the adsorption member 29 becomes smaller than that illustrated in (e) of FIG. 6 described above. As a result, the uppermost sheet P1 can be more reliably separated.

In addition, the description hitherto has been made about a case where the encoder 31 is used to detect that the leading end of the uppermost sheet P1 reaches the registration roller 15 and, after being reached, a voltage is applied to the adsorption member 29, but the invention is not limited thereto. For example, a sensor or the like may be used to detect that the uppermost sheet P1 reaches a conveying roller and, after being detected, the voltage application to the adsorption member 29 may be stopped.

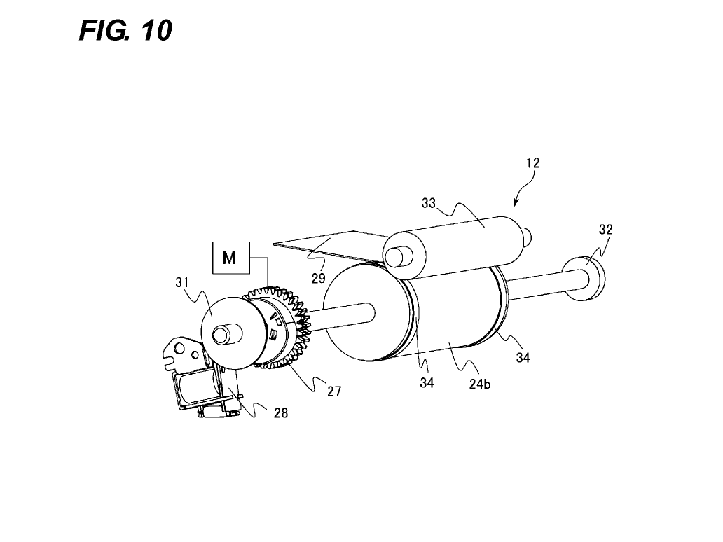

Next, a second embodiment of the invention will be described. FIG. 10 is a diagram for describing a configuration of a sheet feeding device according to this embodiment. Further, in FIG. 10, the same symbols as those of FIG. 3 indicate the same or corresponding portions.

In FIG. 10, a holding member 24b is provided to fix one end of the adsorption member 29 and to hold the adsorption member 29 in a cantilever manner, a sheet charging roller 33 is provided, and the adsorbing force is generated by applying a voltage to the adsorption member 29 by the sheet charging roller 33. In other words, in this embodiment, the sheet charging roller 33 is used as a voltage applying member which generates the adsorbing force by applying a voltage to the adsorption member 29. Herein, the sheet charging roller 33 is formed of a conductive material, and an AC voltage can be applied by an external power source. In addition, the sheet charging roller 33 is urged to the holding member 24b using a spring or the like, and is rotated along the rotation of the holding member 24b.

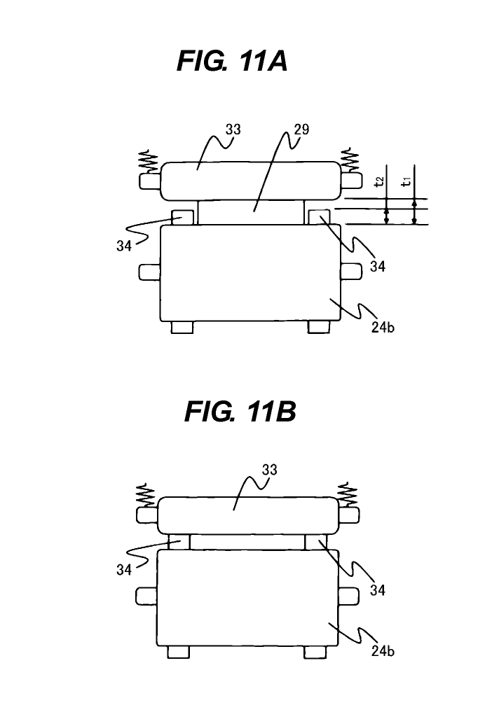

Further, in this embodiment, the adsorption member 29 is configured by a resin flexible sheet having a volume resistivity of 1013 [Ω/cm] or so, but has no electrode. In addition, insulating materials 34 are provided on both end sides in the outer peripheral surface of the holding member 24b, and the adsorption member 29 is fixed between the insulating materials 34. Herein, as illustrated in FIG. 11, a thickness t1 of the adsorption member 29 and a thickness t2 of the insulating material 34 are set to satisfy t1>t2.

Therefore, as illustrated in (a) of FIG. 11, in a case where there is the adsorption member 29 between the sheet charging roller 33 and the holding member 24b, the sheet charging roller 33 and the adsorption member 29 abut on each other. In addition, when the holding member 24b is rotated and the adsorption member 29 disappears from between the sheet charging roller 33 and the holding member 24b, the sheet charging roller 33 and the insulating material 34 abut on each other as illustrated in (b) of FIG. 11. However, even in any case illustrated in (a) and (b) of FIG. 11, the insulation between the sheet charging roller 33 and the holding member 24b is secured.

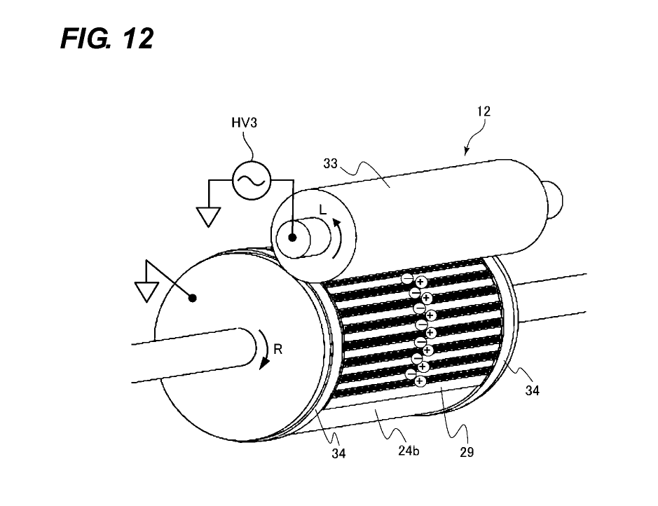

Next, a voltage applying operation to the adsorption member 29 will be described using FIG. 12. When the holding member 24b is rotated in the sheet feeding direction indicated with arrow R, the sheet charging roller 33 is driven by the rotation and rotated in an L direction. Then, the adsorption member 29 passes through between the sheet charging roller 33 and the holding member 24b. At this time, when a sinusoidal voltage of about ±1 kV is applied to the sheet charging roller 33 from a power source HV3 serving as an AC power source, the potential pattern alternating in the stripe shape is formed in the surface of the adsorption member 29. The pitch of this pattern is determined by a frequency of the voltage applied to the sheet charging roller 33 and a rotation speed of the holding member 24b. In addition, the pitch can be preferably set according to conditions, and it may be about 5 mm.

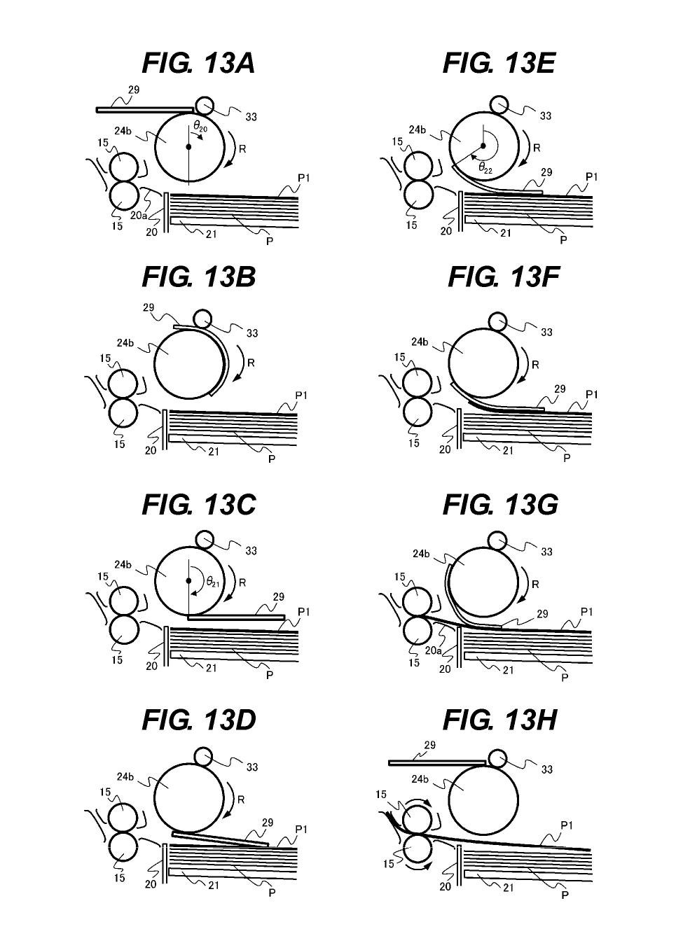

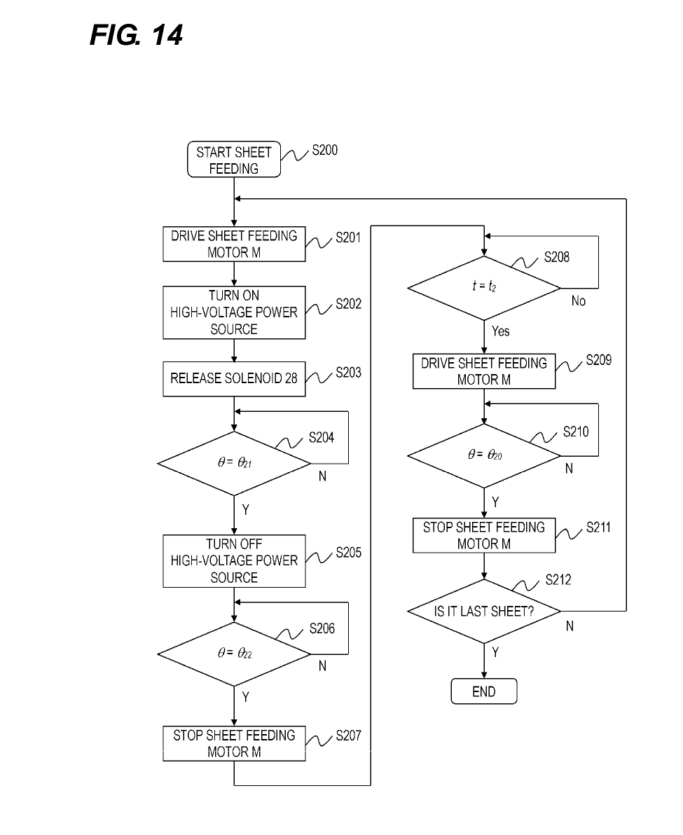

Next, a sheet separating and feeding operation of the adsorbing and feeding section 12 according to this embodiment will be described using FIG. 13 and a flowchart illustrated in FIG. 14. (a) of FIG. 13 is a diagram illustrating the initial state of the sheet feeding device 200 in this embodiment. The rotation angle θ of the holding member 24b at this time is set to an initial rotation angle θ20, and the position is set to the home position (initial position) of the adsorption member 29. In the initial state, the adsorption member 29 is in the non-contact state with respect to the uppermost sheet P1. In addition, the position of the uppermost sheet P1 is regulated by the position of the sheet supporting plate 21.

Next, when the sheet P begins to be fed, the CPU 70 illustrated in FIG. 5 causes the sheet feeding motor M to be driven (S201), turns on the high-voltage power source (S202), and applies the sinusoidal voltage to the sheet charging roller 33. Then, the solenoid 28 is released (S203), and the holding member 24b is rotated in a direction indicated with arrow R. Then, as illustrated in (b) of FIG. 13, the adsorption member 29 passes through between the sheet charging roller 33 and the holding member 24b. At this time, the potential pattern of the stripe shape illustrated in FIG. 12 is formed in the surface of the adsorption member 29.

When the rear end of the adsorption member 29 passes through between the sheet charging roller 33 and the holding member 24b, the adsorption member 29 enters a cantilever state as illustrated in (c) of FIG. 13. Then, when it is determined that the rotation angle θ of the holding member 24b becomes θ21 (Y in S204), the CPU 70 turns off the high-voltage power source (S205) and applies a voltage to the sheet charging roller 33 to stop it. Further, when the holding member 24b is rotated, the adsorption member 29 moves as the rotation, and comes into contact with the uppermost sheet P1 as illustrated in (d) of FIG. 13.

Then, when the surface contact area becomes sufficient for the adsorption, that is, when it is determined that the rotation angle θ of the holding member 24 becomes θ22 as illustrated in (e) of FIG. 13 (Y in S206), the CPU 70 stops the sheet feeding motor M (S207) and stops the rotation of the holding member 24b. At this time, the uppermost sheet P1 is adsorbed to the adsorption member 29 by the static electricity generated on the surface of the adsorption member 29 as illustrated in (f) of FIG. 13. Next, a time taken for stopping the rotation of the holding member 24 to adsorb the uppermost sheet P1 is counted using a timer. Then, when the counted time t becomes t2 (Y in S208), the CPU 70 causes the sheet feeding motor M to be driven (S209), and restarts the rotation of the holding member 24b in a direction indicated with arrow R as illustrated in (g) of FIG. 13.

Herein, when the rotation of the holding member 24b is restarted in a state where the uppermost sheet P1 is adsorbed, the adsorption member 29 is wound up by the holding member 24b while being deformed to be wound to the holding member 24b. Then, when the adsorption member 29 is wound up, the uppermost sheet P1 adsorbed to the adsorption member 29 is turned up, and separated from the lower sheet P. Further, when the adsorption member 29 is deformed to be wound to the holding member 24b, the curvature radius of the adsorption member 29 becomes small. Then, in this embodiment, the force of the adsorption member 29 to adsorb the sheet is set to be smaller than a repulsion force of the uppermost sheet P1 against the bending due to the rigidity of the sheet when a predetermined amount is turned up. Therefore, when the uppermost sheet P1 is turned up by the predetermined amount, the uppermost sheet P1 is separated from the adsorption member 29 due to the rigidity of the sheet.

Next, the CPU 70 causes the holding member 24b to be rotated until the leading end of the uppermost sheet P1 reaches the registration roller 15 on the downstream side in the sheet feeding direction. Thereafter, when the holding member 24b is further rotated, the partially toothed gear 27 returns to the initial position and the drive transmission is stopped, and when the rotation angle θ of the holding member 24b becomes the initial rotation angle θ20 (Y in S210), the sheet feeding motor M is stopped (S211). Therefore, the adsorption member 29 is stopped at the original position (initial position) where the sheet is separated as illustrated in (h) of FIG. 13. Further, thereafter, in a case where the continuous sheet feeding is performed, that is, a case where the fed sheet is not the last one (N in S212), the sheet feeding motor M is driven again. Thereafter, the solenoid 28 is released, and the feeding of the sheet is performed until the last one comes (Y in S212).

As described above, in this embodiment, the sinusoidal voltage is applied to the adsorption member 29 before coming into surface contact with the sheet to apply the adsorbing force to adsorb the sheet by the static electricity. Then, thereafter, when the adsorption member 29 comes into surface contact with the sheet, the rotation of the holding member 24b is temporarily stopped to adsorb the sheet to the adsorption member 29. When the sheet is adsorbed, the rotation of the holding member 24b is restarted to wind up the adsorption member 29. With such a configuration, similarly to the first embodiment described above, the configuration can be simplified, and the screechy noises can be reduced.

Further, in the above embodiment, the description has been made about that the home position (initial position) of the adsorption member 29 is set to a position (non-contact state) where the uppermost sheet P1 is separated, but the feeding may be started from a state where the adsorption member 29 comes into contact with the uppermost sheet P1. With such a configuration, it is possible to reduce noises when the adsorption member 29 comes into surface contact with the uppermost sheet P1. Further, in such a case of the configuration, after the sheet feeding operation is started, the adsorbing force to adsorb the sheet can be applied by applying a voltage to the adsorption member 29 without being grounded.

### REFERENCE SIGNS LIST

12 adsorbing and feeding section
15 registration roller
20 sheet feeding cassette
24 holding member
24a projection
24b holding member
26 power electrode
29 adsorption member
30a first comb-tooth electrode
30b second comb-tooth electrode
31 encoder
33 sheet charging roller
73 timer
100 full-color laser beam printer
100A full-color laser beam printer body
100B image forming section
200 sheet feeding device
HV1, 2 high-voltage power source
HV3 power source
M sheet feeding motor
P sheet
P1 uppermost sheet

1. A sheet feeding device comprising:
a loading portion configured to be loaded with a sheet;
a rotation member configured to be disposed on an upper side of the loading portion;
an adsorption member configured to have ends and to be provided such that a part of the adsorption member is fixed to the rotation member and the sheet loaded on the loading portion is electrically adsorbed;
a driving unit configured to rotate the rotation member; and
a control unit configured to control the driving unit.

2. The sheet feeding device according to claim 1,
wherein the adsorption member is provided to be capable of moving from an initial position which is a position separated from the sheet loaded on the loading portion to a contact position which is a position coming into contact with the sheet loaded on the loading portion, and
wherein the control unit causes the adsorption member to move from the initial position to the contact position by rotating the rotation member, and then stops the adsorption member at the contact position for a predetermined time.

3. The sheet feeding device according to claim 1, further comprising:
a conveyance unit configured to convey the sheet adsorbed by the adsorption member,
wherein the control unit rotates the rotation member to deliver the sheet adsorbed to the adsorption member to the conveyance unit, and then stops the rotation of the rotation member.

4. The sheet feeding device according to claim 2, further comprising:
a power source configured to apply a voltage to the adsorption member to apply an adsorbing force so as to adsorb the sheet by static electricity,
wherein the control unit applies a voltage from the power source to the adsorption member in a state where the adsorption member is stopped at the contact position.

5. The sheet feeding device according to claim 2,
wherein the adsorption member is flexible and, in a state where the adsorption member is positioned at the contact position, disposed at a position where an upstream portion in a sheet feeding direction comes into contact with the sheet loaded on the loading portion and a downstream portion in the sheet feeding direction is separated from the sheet loaded on the loading portion.

6. The sheet feeding device according to claim 1,
wherein the adsorption member is supported by the rotation member through an elastic material attached to a peripheral surface of the rotation member.

7. The sheet feeding device according to claim 1, further comprising
a detection unit configured to detect a rotation amount of the rotation member,
wherein the control unit controls the driving unit based on a detection result of the detection unit.

8. The sheet feeding device according to claim 1, further comprising
a pressing portion configured to press the adsorption member, which is provided in the rotation member and serves to separate the sheet adsorbed to the adsorption member from the adsorption member.

9. The sheet feeding device according to claim 1,
wherein a magnitude of an adsorbing force by static electricity when the adsorption member is wound up is set to a magnitude at which the sheet is separated from the adsorption member by a rigidity of the sheet.

10. The sheet feeding device according to claim 4,
wherein two electrodes are disposed in the adsorption member, and
wherein the power source includes a first power source which applies a positive voltage on one of the two electrodes, and a second power source which applies a negative voltage to the other one of the two electrodes.

11. The sheet feeding device according to claim 4, further comprising
a voltage applying member configured to be provided between the adsorption member and the power source, and to abut on the adsorption member before the adsorption member comes into contact with the sheet so as to apply a voltage from the power source to the adsorption member.

12. The sheet feeding device according to claim 11,
wherein the power source is an AC power source.

13. An image forming apparatus comprising:
an image forming section configured to form an image on a sheet;
a loading portion configured to be loaded with a sheet;
a rotation member configured to be disposed on an upper side of the loading portion;
an adsorption member configured to have ends and to be provided such that a part of the adsorption member is fixed to the rotation member and the sheet loaded on the loading portion is electrically adsorbed;
a driving unit configured to rotate the rotation member; and
a control unit configured to control the driving unit.
